(19) United States
(12) Patent Application Publication
(10) Pub. No.: US 2002/0069405 A1
(43) Pub. Date: Jun. 6, 2002

(54) System and method for spokesperson interactive television advertisements

(76) Inventors: Paul W. Chapin, Edina, MN (US); Scott J. Sample, Blaine, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/960,262

(22) Filed: Sep. 20, 2001

Related U.S. Application Data
(60) Provisional application No. 60/234,070, filed on Sep. 20, 2000.

(51) Int. Cl. H04N 7/025; H04N 7/10; H04N 7/16; G09G 5/00

(52) U.S. Cl. 725/32; 725/36; 725/135; 725/136; 345/700

(57) ABSTRACT

The present invention relates to a spokesperson model for interactive video advertisement packages. The interactive video advertisement package is delivered over a broadcast interactive television medium, an initial real time, predetermined video advertisement segment is delivered in a conventional advertising spot time frame. The initial video advertisement segment includes a dynamic sequence presenting a spokesperson representation having a plurality of selectable zones. Each zone is defined in relation to a unique part of the spokesperson representation and has a corresponding selectable, predetermined video advertisement segments associated with that zone. One of the selectable video advertisement segments corresponding to a viewer selected zone is delivered to the viewer in direct response to selection by the viewer of that zone.

### RELATED APPLICATIONS

This application claims the benefit of U.S. Provisional Patent Application No. 60/234,070, filed Sep. 20, 2000, incorporated herein in its entirety by reference.

### FIELD OF THE INVENTION

This invention relates to interactive video distribution processes, systems, and elements thereof characterized by point-to-multipoint system configurations, and which are used for the unidirectional distribution or delivery of motion video data resulting from interactions between users and systems elements. In particular, this invention relates to interactive advertisements or commercial information displays that offer viewers an opportunity to interact with a representation of a spokesperson by selecting a selectable zone that is defined in relation to a unique part of the spokesperson representation to view advertisements and/or other information associated with the selected zone.

### BACKGROUND OF THE INVENTION

During the past two to three decades, the public has had the opportunity to observe significant developments in two important communications medium, television and the Internet. Developments in television include, for example, high resolution color television, home video machines, cable and satellite broadcasting, digital television, and interactive television. Developments in the Internet have focused on increasing “last mile” bandwidth by designing, for example, faster routers and on decreasing server response time by moving content closer to the edge of the network through the use of web caching and content replication.

Although television—herein used to refer to all forms of real time audio-video broadcast networks such as conventional television, cable, and satellite—and the Internet are viewable on similar video display devices, the differences between these two mediums remain profound. There are several reasons for this. First, the Internet remains a two-way medium carrying largely static content for point-to-point distribution, while television in general is a real time, dedicated one-way medium with dynamic content for point-to-multipoint distribution or broadcasting. Second, distributing a web page from a computer browser output directly onto a television display is not a very satisfying experience, because of what is often referred to as the “twelve inch versus twelve foot experience”. Internet content is usually viewed by a single user sitting close to a computer display, and Web page fonts and graphics are generally too small to be comfortably viewed on a television display without specially transcoding the content. Television content is usually viewed from greater distances and often by a group of viewers, and broadcast networks are designed to transmit rich, multimedia content by delivering a high-quality, synchronized audio and video signal to a large viewer population. Third, the Internet is a “best-efforts” network. Data moves through networks in a hop-by-hop, asynchronous manner and some data packets can be dropped arbitrarily or delayed. These errors introduce a degree of unpredictability and unreliability in content delivery in addition to server response time problems. Broadcast networks provide predictable performance; because of their synchronized point-to-multipoint transmission, there are no variances in the propagation delay of data throughout a network's transmission footprint. Finally, the Internet is not readily scalable in terms of point-to-multipoint transmissions. As a point-to-point network, when data needs to be sent to several locations, additional copies of the same data are sent separately. In contrast, broadcast networks are inherently scalable because of their point-to-multipoint transmission capability. Because of all these differences, concepts and techniques for allowing individual interaction with Internet context are generally not transferable to the medium of television, even the advancements with respect to interactive television.

Interactive television is television enhanced with the attributes of personalization and responsiveness by designing choice into the medium such as has the Internet. The term “interactive television” thus can generally be defined as anything that allows a viewer to selectively engage a television broadcast system to access new and/or advanced presentations other than by channel selection. Unlike the Internet, however, interactive television has dedicated, real time continuous broadcasting unless a viewer chooses to interrupt the real time content by selectively requesting an alternative presentation.

Examples of Internet/computer experiences are Doyle, U.S. Pat. No. 4,847,604, Method and Apparatus for Identifying Features of an Image on a Video Display, and Makkuni et al., U.S. Pat. No. 5,010,500, Gesture Modified Diagram for Retrieval of Image Resembling Diagram, with Parts Selectable for Further Interactive Retrieval. Doyle teaches about a computer display graphic interface that allows a user to obtain descriptive information concerning a feature of a displayed image by pointing to the location of the feature. Makkuni et al. teach about selecting a part of a still image in a workstation environment to display a menu that includes a description of video segments related to that part. Because both of these inventions are twelve inch experiences, they are not readily adaptable to the interactive television medium.

Examples of a twelve foot interactive television experience can be found in Hayashi, U.S. Pat. No. 5,995,134, Method and Apparatus for Enticing a Passive Television Viewer by Automatically Playing Promotional Presentations of Selectable Options in Response to the Viewer's Inactivity; Hooks et al., U.S. Pat. No. 6,169,542 B1, Method of Delivering Advertising Through an Interactive Video Distribution System; and Clanton, III et al., U.S. Pat. No. 5,745,710, Graphical User Interface for Selection of Audiovisual Programming. Hayashi teaches about a system for displaying a menu of promotional presentation options wherein the system defaults to presenting one of the presentations if the viewer fails to select an option within a given amount of time. Hooks et al. teaches about a menu of selectable options built up from advertisements for which a registration request was received by a viewer. In each of these patents, then, it is necessary for a viewer to select an option, or to wait for a default selection from among the selectable options to begin, before the system will continue in real time. Clanton, III et al. teach about an interface for displaying and selecting video-on-demand programs as well as other programs and interactive services. Clanton, III et al. disclose a movie studio back lot metaphor having a poster wall that presents a series of movie posters representing available movie selections. In addition to the posters, the back lot metaphor includes extras that are anthropomorphic character metaphors for movie categories or advertisements of specific movies. Selecting an icon in the form of a poster or character transforms the icon into a movie poster or advertisement for a poster. Extras may also advertise related services available to the user, including for example, pizza delivery services, national or local merchants, or news, weather, or sports programming. These extras are associated with a single service and have no independent significance apart from the back lot metaphor for choosing movie entertainment. Moreover, like Hayashi and Hooks et al., the invention in Clanton III, et al. does not continue in real time unless and until the viewer selects an icon.

Kitsukawa et al., U.S. Pat. No. 6,282,713 B1, Method and Apparatus for Providing On-Demand Electronic Advertising, is also an example of the twelve foot interactive television experience. Kitsukawa et al. teach about a video broadcast network related invention wherein on-demand advertisements are provided for items and services used in scenes of television programming. Selected advertisement modes alert a viewer when advertising information is available as a selectable option within the context of the broadcast programming. The alert comprises a tone and indicator marks that are superimposed over broadcasted programming. An advertisement for a particular item is requested by a viewer by selecting the indicator marks corresponding to the item in which the viewer is interested. The advertisement is then displayed along with the broadcast of the current television programming by superimposing the advertisement over the broadcast of the television programming or on a portion of the display along with the television programming, either of which may be displayed in a picture-in-picture inset. This mode of advertising has several disadvantages. From a viewer's perspective, an advertisement cannot be viewed in advertising mode unless a viewer does so in cyber time, thus forcing the viewer to break his or her focus away from real time programming. From an advertiser's perspective, the viewer is not exposed to advertisements unless the viewer selects an advertising mode, and a product or service cannot be advertised independently from the television programming. To make use of this invention, it is necessary to abandon the existing models of advertising whereby discrete broadcast time slots are sold to promoters and advertisers.

Although numerous attempts have been made to provide more interactive advertisement opportunities, existing techniques are either not suitable for the interactive television medium, because they rely on the assumptions inherent in the twelve inch experience of the Internet, or because they require user interaction or time delay before continuing. The undesirable results of this latter reason are especially noticeable in those situations where not all viewers have interactive capabilities. Accordingly, it would be desirable to provide an advertisement delivery system that is particularly adapted to the interactive television medium and that can take advantage of the benefits associated with a representation of an advertisement spokesperson.

### SUMMARY OF THE INVENTION

The present invention introduces a new paradigm in interactive advertising, the spokesperson model. This model allows television viewers to interact with a representation of a spokesperson in a television advertisement or program. Depending on the viewer's interaction, different scenarios develop on the television display. The interactions may control the actions of the representation and can facilitate ordering products or services, requesting more information about a product or service, entering contests, playing games, choosing between multiple commercial messages, or linking to a related web site.

This invention is a significant development with respect to the method by which advertisers may be charged for a spokesperson's services and for the advertising time provided by a broadcast network. In traditional advertising, a product or service provider hires a spokesperson to appear in an advertisement. The provider pays the spokesperson a negotiated fee and pays the broadcast network a placement fee for each advertisement segment that is run. In the new model provided by the present invention, the spokesperson can be paid a fee by several different providers for a single appearance, as each provider may have its own scenarios with which the viewer can interact. Alternatively, a single provider might also advertise several products associated with that provider. On the other hand, a broadcast network can charge an incremental fee beyond its normal placement fee, since multiple products are being represented and since the viewer's interacting with an advertisement package might cause the advertisement package to extend beyond its real time allotted time slot.

The present invention relates to a spokesperson model for interactive video advertisement packages. The interactive video advertisement package is delivered over a broadcast interactive television medium, an initial real time, predetermined video advertisement segment is delivered in a conventional advertising spot time frame. The initial video advertisement segment includes a dynamic sequence presenting a spokesperson representation having a plurality of selectable zones. Each zone is defined in relation to a unique part of the spokesperson representation and has a corresponding selectable, predetermined video advertisement segments associated with that zone. One of the selectable video advertisement segments corresponding to a viewer selected zone is delivered to the viewer in direct response to selection by the viewer of that zone.

Interactive advertising can run in either real time or cyber time. Real time advertising is advertising the way the viewer has traditionally viewed television. The time frame of the advertising is continuous during broadcasting and never interrupted. It may or may not be selectable, an example of the former being video-on-demand. Cyber time programming is programming that is both selectable and can be interrupted. Selectable zones are used to move between selections in real time, between real time and cyber time, or between two selections occurring in cyber time. The term selectable zone refers to an area on a video display, which if selected by any mechanism such as a mouse, joystick, IR remote control, voice recognition, or keyboard, causes some computer process to happen, such as reconfiguring the display. It will be understood that any number of hardware and software platforms of the broadcast interactive television medium can be utilized to implement the spokesperson model in accordance with the present invention. Moreover, advertising packages and the advertising segments that make up these packages can be stored at and called from the viewer's set-top box or from a broadcast server.

This model of advertising is designed to work either in or out of real time. If the viewer chooses not to interact, real time advertising continues at the end of the advertisement's time slot and the viewer never leaves real time. At any point in the initial advertisement segment that the viewer makes a selection, the viewer most likely will begin viewing in cyber time, depending on the advertising package and the choices made by the viewer.

The motivation behind this model of advertising is to allow the viewer to choose a predefined message for a predefined product or company to be delivered by a spokesperson representation. How the viewer interacts with the image they see on the television specifically defines what message the viewer will receive. In this model it appears as though the viewer has control, and to a certain extent the viewer does have control, of the message that is delivered. Preferably, this model has messages and content delivered almost instantaneously to the viewer to give the viewer the appearance of “real time” interactivity with the spokesperson representation.

### BRIEF DESCRIPTION OF THE DRAWINGS

FIG. 1 is an illustration of the initial sequence of a spokesperson model interactive video advertisement package using the same home position as the beginning of each advertisement segment corresponding to a selectable zone.

FIGS. 2-4 are illustrations of different selectable advertisement segments that each correspond to a selectable zone.

FIG. 5 is an illustration of an end transition sequence using the same home position as the beginning of each initial advertisement segment.

FIG. 6 is an illustration of the beginning of a spokesperson model interactive video advertisement package using the same home position as the beginning of each advertisement segment.

FIG. 7 is an illustration of a response to an inappropriate viewer selection.

FIGS. 8-10 are illustrations of different selectable advertisement segments that each correspond to a selectable zone.

FIG. 11 is an illustration of a transition using the same home position as the beginning of each advertisement segment.

FIG. 12 is a diagram illustrating an interactive television environment.

### DETAILED DESCRIPTION OF THE PREFERRED EMBODIMENTS

The spokesperson model for interactive advertising presents a representation of one or more persons, characters, or objects either in real or animated form. A spokesperson can be a person or object that is recognizable to an audience, which may be a general public viewing audience, a regional or local audience, or even an audience having some other commonality. Examples of spokespersons for the general public might be nationally recognizable performers, models, athletes, cartoon characters, and heroes and political figures. Examples of a spokesperson for a regional audience might be team mascots, athletes, and political figures. Examples of spokespersons for audiences having some commonality are personified company logos or mascots, company officers, and people well known in their field of expertise. Moreover, recognition may be inherent in the spokesperson because of prior public exposure or may be built up through repetitive advertising that exposes the spokesperson to an audience. What is important is using this recognition to engage an audience's interest in being entertained by an advertisement in a manner that is interactive and that gives the appearance that the viewer is interacting with the spokesperson in continuous real time.

At the beginning of an interactive video advertisement package 10 as shown in FIGS. 15, a spokesperson representation 15 can be introduced or can introduce itself to a viewer to engage the viewer 11, and the viewer is informed that the advertisement is interactive 12 by, for example, a displayed message, displayed interactive “i” logo, or an announcer or a spokesperson 15. The viewer might also be instructed how to interact 13 with the spokesperson representation 15. The spokesperson representation 15 subsequently begins to entertain the viewer by engaging the viewer audibly through voice or other sounds, visually through movement, or both.

If the viewer is not previously informed how to interact with the spokesperson representation 15, the spokesperson representation 15 may do this next. The viewer is informed that he or she may select a selectable zone 14 on the spokesperson representation 15 anywhere on the display and receive an entertaining message or presentation. These zones 14 may include any part of the spokesperson representation 15. A spokesperson representation 15 may be mapped into one or multiple selectable zones 14, each signifying a different presentation for the viewer depending on what part of the representation 15 the viewer selects. The selectable zones 14 may also include a margin 16 around a mapped image so that the viewer can more conveniently select a zone 14.

If the viewer does not to make a selection, the advertisement package continues to entertain the viewer in real time in some manner until its allotted time ends. If a viewer does make a selection, a subsequently delivered advertisement segment may or may not have selectable options for further interaction. These options include selecting another advertisement segment, linking to a web site, establishing a communication link for communicating to a third party, or any combination of the three. Each selected advertisement segment, web link, or communication link occurs in cyber time. A selected advertisement segment returns to real time at its conclusion if another selection has not been made, and any cyber time selection may be interrupted by the viewer at any time to return to real time broadcasting. For example, a picture-in-picture window with real time programming can be displayed, which if selected, will return the viewer to real time. The kinds of advertisements that may be presented are virtually limitless. Significant to the spokesperson model, however, is that a representation of a spokesperson is in almost every selected advertisement segment.

A spokesperson representation 15 returns to a specific “home” position 17 after first inviting the viewer to select a selectable zone 14 and at the beginning and end of each subsequent advertisement segment. This allows for seamless movement from the introductory of the real time presentation to a selected advertisement segment and between selected advertisement segments, i.e., at the transitions. Moreover, each selected zone 14 will correspondingly move with a moving part of a person, character, or object. Special effects may also be added, such as causing an object to appear in the hot zone of a selected option.

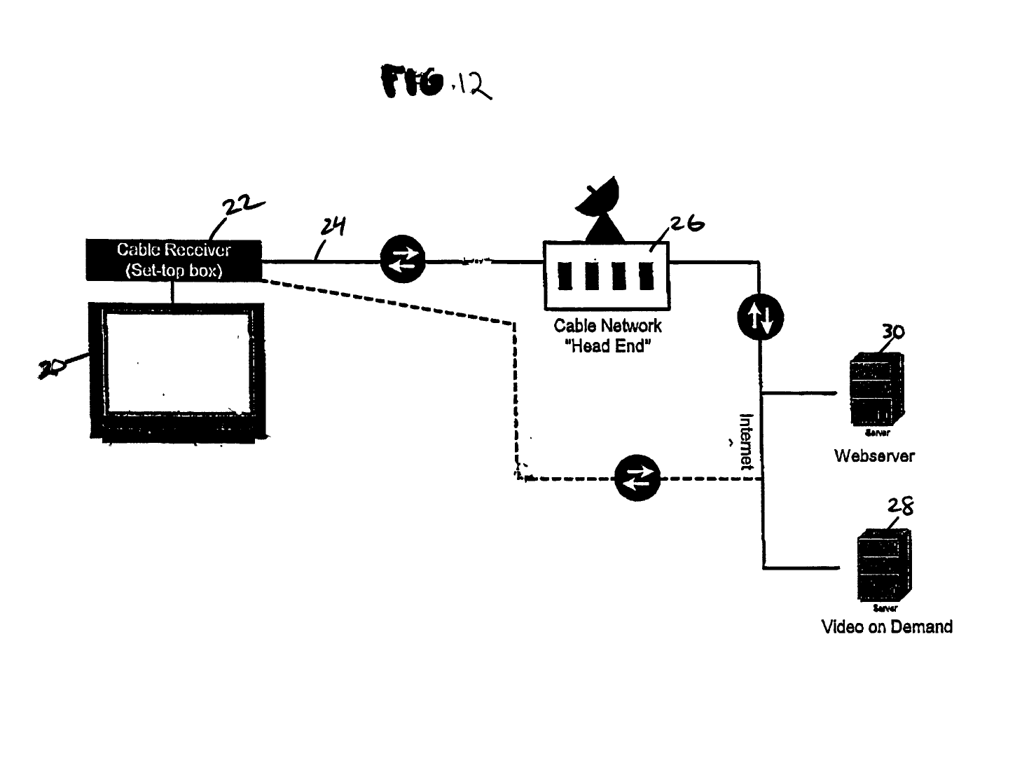

Previously television has been a unidirectional medium in that programming and information has moved from broadcast network to viewer, but not vice versa. Recently, limited interactivity has become possible, usually by small amounts of data that are transmitted during the vertical blanking interval (VBI) of a television signal. This data is typically displayed as an overlay to the television broadcast signal. One embodiment of a broadcast interactive television environment is illustrated in FIG. 12. It will be understood that any number of interactive television configurations can be used to implement the environment in accordance with the needs of the present invention. An interactive viewer has a television 20 equipped with an upgraded cable receiver 22, for example an AT&T DCT 5000, and is able to view interactive television content via his/her cable network 24. While viewing scheduled television programming, an interactive advertisement package having a spokesperson representation of a sports celebrity, for example, appears during a commercial break. For example, the advertisement package is streamed from the cable network head end facility 26 in the same manner as traditional programming, except that ATVEF (Advanced TV Enhancement Forum) standard triggers have been embedded in the video stream in a post-production video editing procedure. These triggers are interpreted by the cable receiver 22 and are translated into selectable zones laid over the video content. Preferably, these selectable zones move with the spokesperson representation as the spokesperson representation moves on the television display.

While watching the advertising package, the viewer is encouraged to interact with the spokesperson by selecting a selectable zone. The spokesperson representation may mention this as part of its presentation or the opportunity may be indicated by an on-screen graphic or icon. The advertisement segments of the advertisement package are linked in such a manner that interacting with the spokesperson representation will cause its on-screen behavior to react to the viewer's selection. For example, the spokesperson might involve the viewer in a video game, a product or service advertisement, an advertisement segment that continues seamlessly from the previous advertising segment, a web site, communication link, or any combination of these. Alternately, the viewer may elect not to interact. If the viewer does not elect to interact or is not able to interact, then the initial real time advertisement segment continues to fill the advertisement's time slot.

If, for example, a video game is to appear, preferably what happens is the following: Viewers begin by watching an advertising segment that is streamed from the cable head end facility to all receivers within the cable network. All viewers begin by viewing the same content simultaneously. A viewer can then select the selectable zone that initiates the response having the video game.

Selecting the zone triggers a “hot spot” overlay which sends ATVEF instructions to retrieve the next advertisement segment from a video-on-demand server 28. This video-on-demand server 28 is connected to the a network and the viewer's television 20 is connected to the network by, for example as shown in FIG. 12, either a broadband internet connection through the cable network or a broadband internet connection through a telephone network (DSL, ATM, T-1). A new advertisement segment is streamed to the viewer's cable receiver 22 and television 20 that is video of the spokesperson representation and seamlessly fits with the initial video advertisement segment. The term “seamlessly” means more than the absence of gaps between serial segments; it means that there are no jitters during the transition between the two segments. As an alternative, all the segments can be downloaded at once and stored in the memory of a set-top box 22.

At the conclusion of the segment, a command is embedded in the video (ATVEF) that instructs the cable controller to retrieve the video game content from a web server 30. Once downloaded to the cable controller, the game is ready to play.

At the conclusion of the video game, the viewer's score is uploaded to the web server 30 and stored in a database along with viewer demographic information such as the viewer's name, address, telephone number, and email address, all of which might be stored in memory within the cable receiver or on a smart card that is inserted into the cable receiver. This information might be used for a contest as well as database marketing and advertising analysis.

Also at the conclusion of the videogame, an embedded command (ATVEF) is sent to retrieve a final advertisement segment from the video-on-demand server 28. At the conclusion of this final segment, an ATVEF command is embedded that instructs the cable receiver 22 to return to the broadcast video stream originating from the cable network head end 26. This video stream from the head end 26 could contain a next advertisement or could be a continuation of scheduled programming.

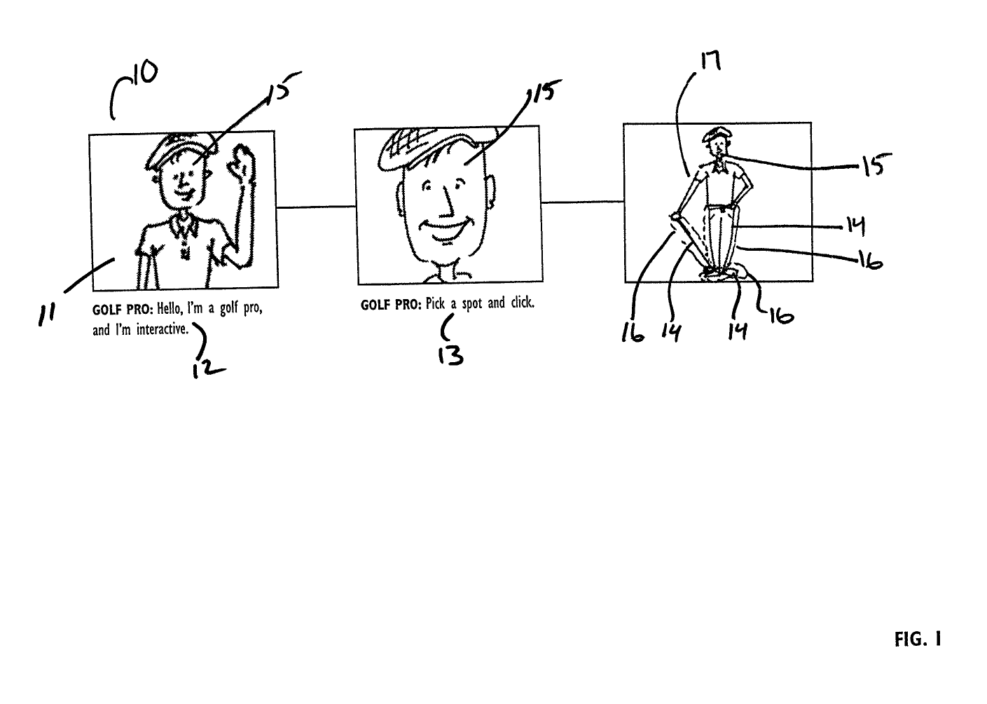

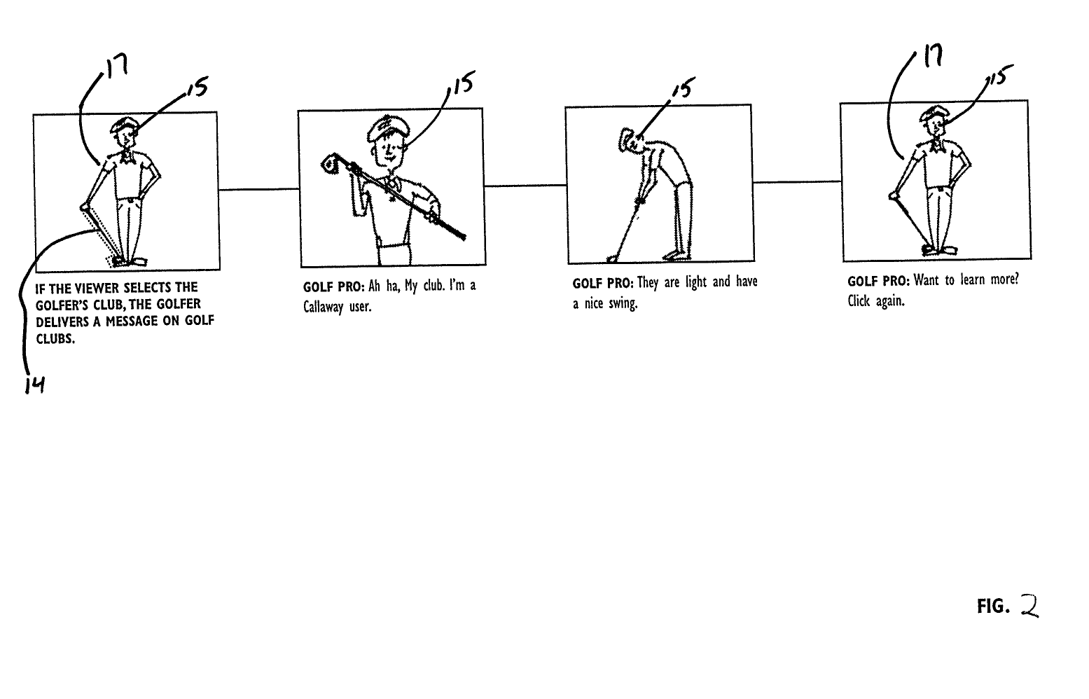

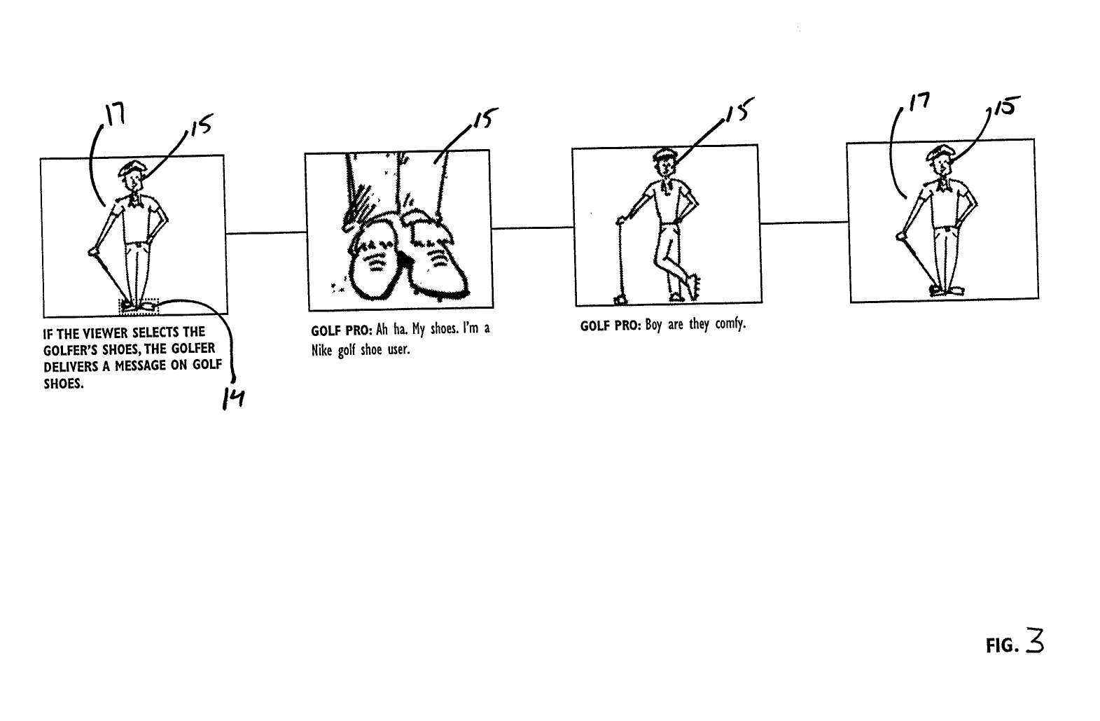

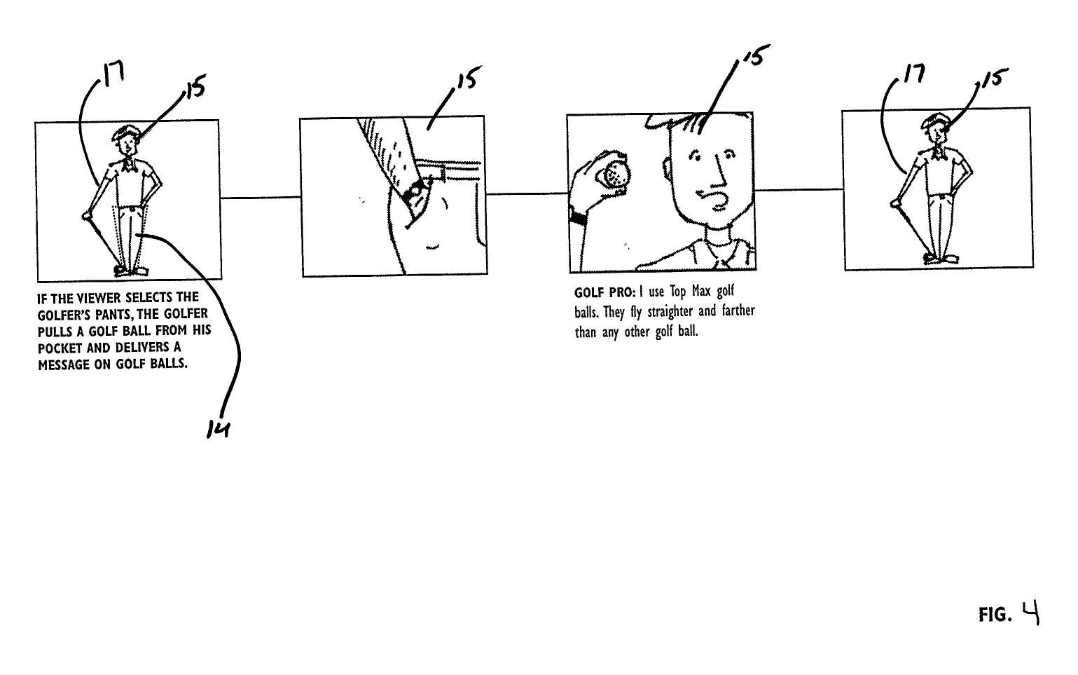

In one embodiment of this invention as illustrated in FIGS. 1-5, the interactive video advertisement package begins with the representation of a famous, engaging personality such as a celebrity golfer inviting the viewer to interact with him or her. In FIG. 1, the viewer is directed by the spokesperson representation to click in various places on the display. Once the viewer chooses a spot and clicks, the spokesperson goes into action, which in this model is virtually limitless. First the spokesperson representation will always return to a specific position after inviting the viewer to click. This will allow seamless movement from their introduction to interactivity. Second, each area that is clickable is mapped so that the viewer's clicking area is easy to use. Third, special effects and other technical tools can be fully employed to make an advertising segment most interesting. For example, if the viewer clicks on a hand, a soda bottle may appear in the hand, followed by a message for a beverage. As another example, a spot might begin with a golfer leaning on one of his golf clubs. The golfer introduces him- or herself, informs the viewer that the representation is interactive, and that the viewer should pick a spot and click. The viewer can now click on a golf club that the golfer is holding as in FIG. 2, the golfer's pants as in FIG. 4, his shoes as in FIG. 3, or wherever else the viewer is interested and that is mapped with a selectable zone. An advertisement segment is then delivered to the viewer that corresponds to the selectable zone on which the viewer clicked. For example, if the viewer clicks on the golf club, the golfer might say, “Ah ha. My clubs. I'm a Callaway guy”, and then continue with a message for a certain kind of golf club. If the golfer clicks on the golfer's shoes, the golfer might begins with a message about a certain kind of sports shoes. Or if the viewer clicks on the golfer's pants, the golfer might pull a golf ball from his pocket and delivers a message for a certain brand of golf ball.

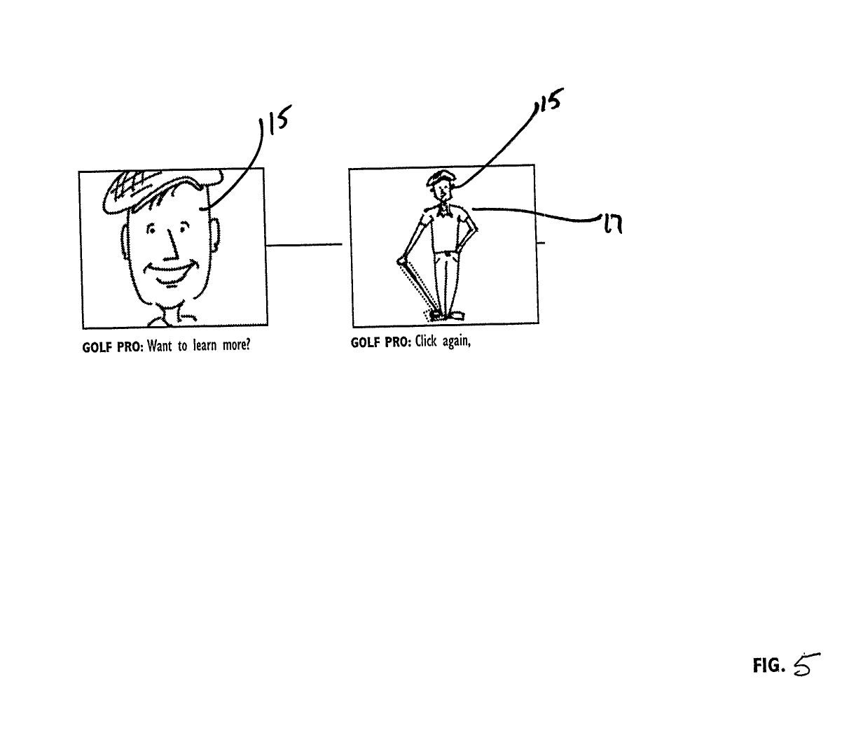

After an advertisement segment is delivered the golfer would end his sequence by returning to a “home” position as in FIG. 5. At this point, the viewer again can select a selectable zone to trigger any number of additional advertisement segments. In addition, the amount of interactivity though out the duration of the advertisement package can be implemented to allow the user to select into multiple levels. If the viewer does nothing the golfer entices the viewer to click. If viewer decides to remain passive, the golfer says goodbye and real time programming continues. Thus, this model is designed to work either in or out of real time. If the viewer does not interact, programming continues at the end of the allotted real time interval of the advertising package, never leaving real time. At any time in this model that the viewer clicks, the advertisement package switches to cyber time. The spokesperson representation delivers messages for the advertisers involved, resulting in anything from a brand message to inviting specific interactivity, such as ordering a box of golf balls.

The technology for this example becomes involved if it is to appear to the viewer that the interactivity looks seamless. Multiple scenarios must be scripted, storyboarded, and shot to define the different paths that the viewer might select. In essence, for every selection a viewer can make, a separate advertisement segment is produced. In a post production procedure, the spokesperson representation is digitized, isolated, and carefully outlined on a frame by frame basis. This procedure is commonly referred to as image mapping. Once this is done, separate areas of the mapped image can be defined as unique selectable zones that can be activated by the equivalent of a mouse click. When the viewer clicks on one of these selectable zones, a signal is sent to the processor in a set-top box to retrieve the corresponding content from its own hard drive or a server. For this to happen, either the interactive advertisement package must be loaded ahead of time into a set-top box with enough memory and speed to deliver the content in the desired fashion, or there must be enough bandwidth on the line feeding the users set-top box, preferably 1.5 to 3 mbps, to access the information from a remote server. If done correctly, the viewer should have the perception that clicking on a certain part of the spokesperson representation triggers an instantaneous response. Each time an advertisement segment is completed by the spokesperson representation, it settles into a home position that again allows the viewer to choose how to interact. The viewer may stay as long as he or she wants to interact with a predefined amount of content or return to regular programming at any time. For the viewer to know what is being broadcasted in real time, a picture-in-picture technology is included in each selected advertisement segment that, when clicked, allows the viewer to return to the real time broadcast signal. The editorial process of the spokesperson model is also important. There must be a common home position for transitioning between advertisement segments for continuous, seamless interactivity beyond delivering a single message to the viewer.

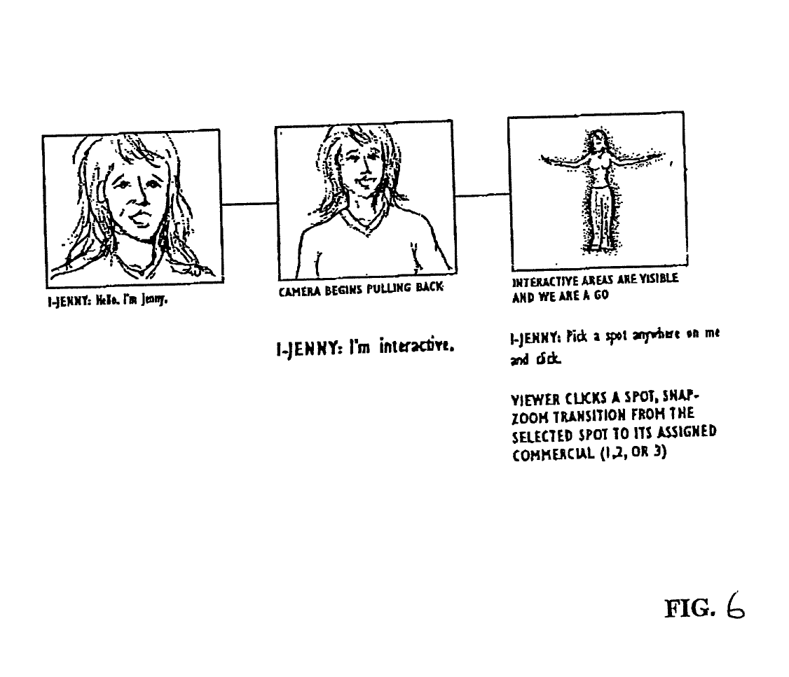

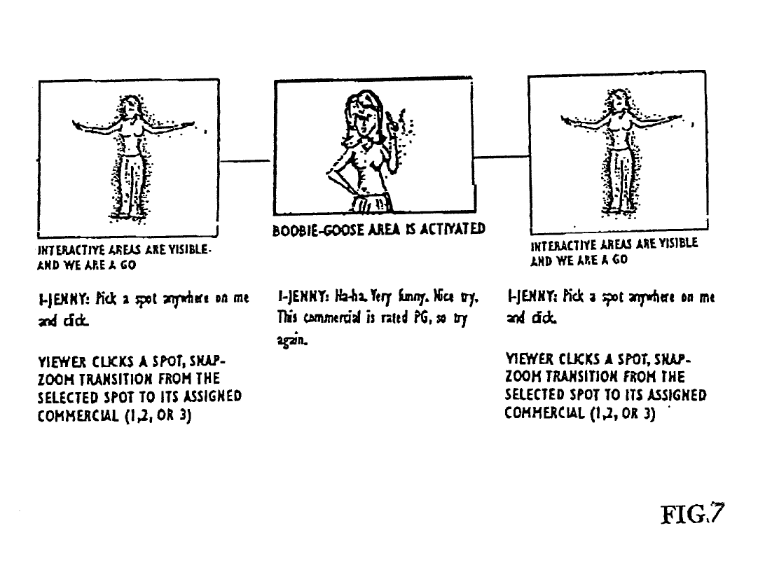

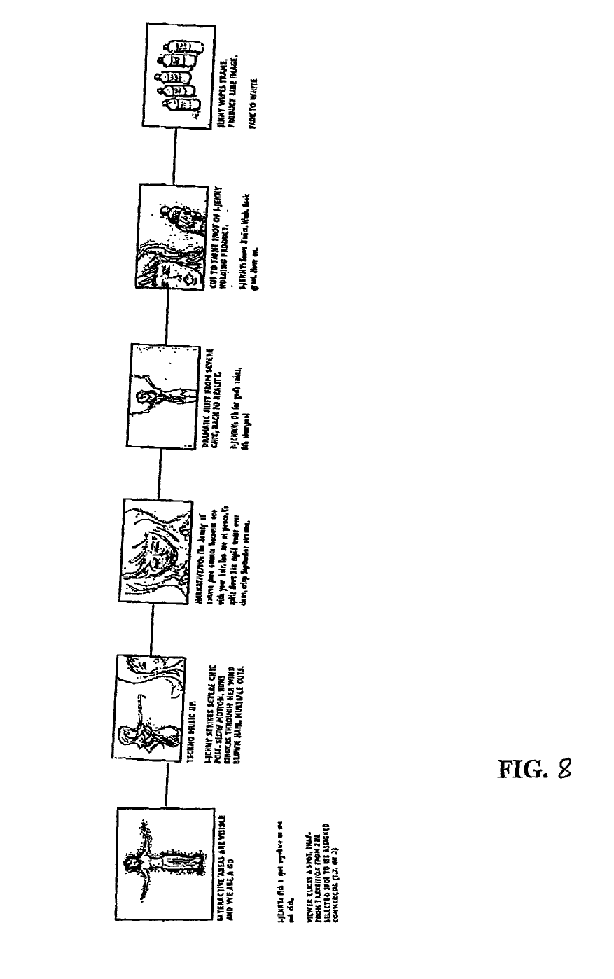

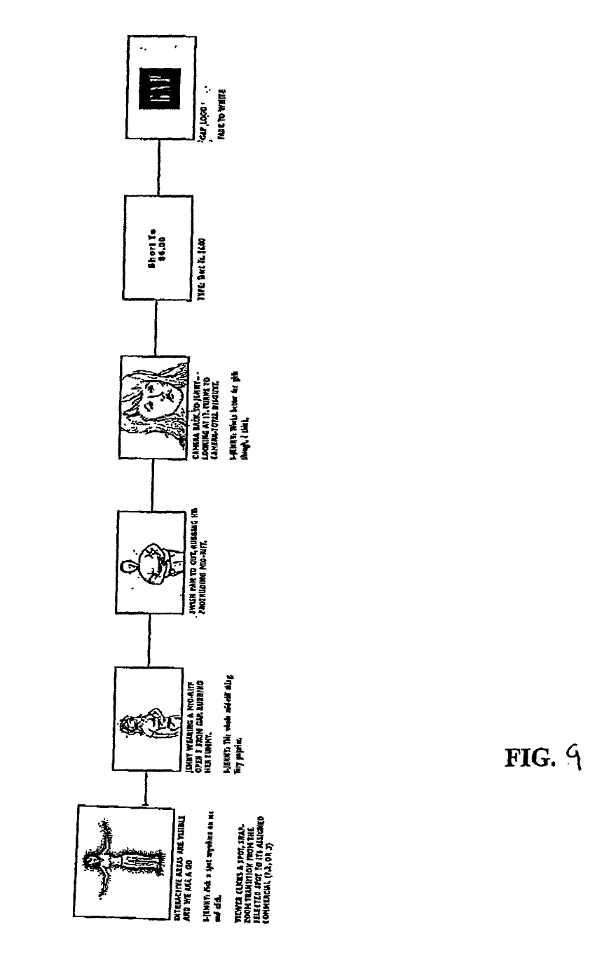

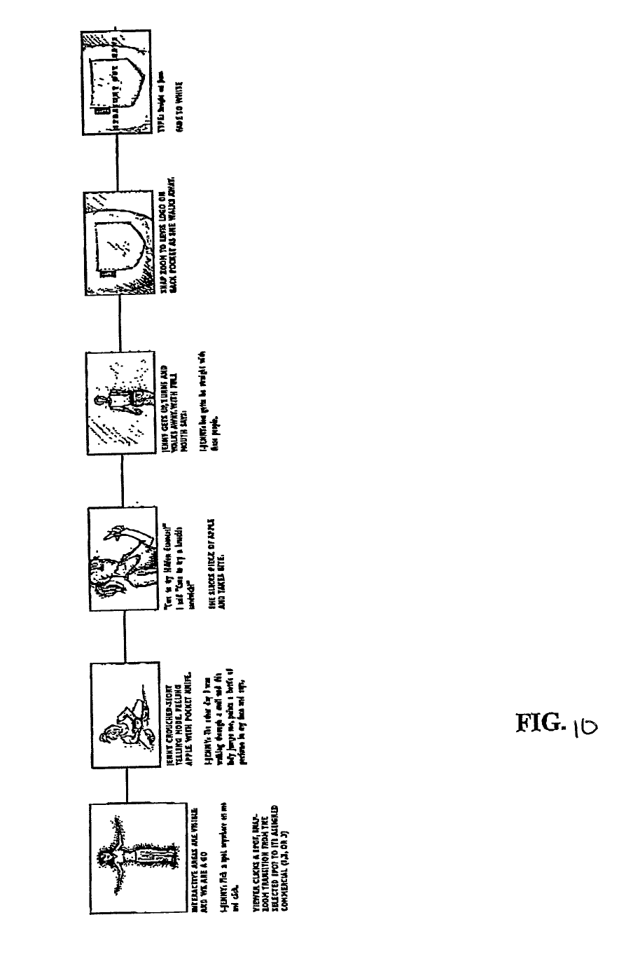

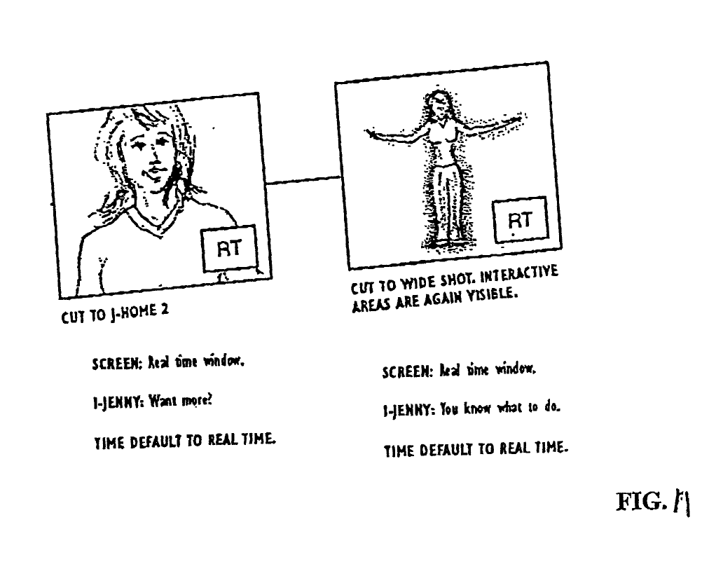

Another embodiment of the spokesperson model is the interactive advertisement layout shown in FIGS. 6 through 11, the “Jenny model”. This advertisement focuses on a teenage girl as spokesperson. FIG. 6 shows the beginning of a real time presentation in which the Jenny model introduces herself, informs the viewer that the advertisement is interactive, and invites the viewer to participate. The Jenny model then transitions to a home position so that the advertisement appears seamless if the viewer selects a selectable option. One of the presentations in FIGS. 8 through 10 is incorporated into the real time presentation and therefore will not appear as a presentation signified by a selectable option. The other two presentations will be presented only if the viewer selects the selectable option with which they are signified. As in FIG. 7, if a viewer attempts to explore what might be considered private areas of the spokesperson representation, the spokesperson representation may tell the viewer to try somewhere else. This message may also appear to seamlessly transition from the real time presentation. FIGS. 7 through 10 each points to a common series of frames as shown in FIG. 11 in which the Jenny model invites the viewer to continue to interact and returns the Jenny model to the home position so that seamless transitioning occurs. If the viewer does not select again, the advertisement returns the viewer to real time programming.

What is claimed:

1. An interactive video advertisement package for delivery over a broadcast interactive television medium comprising:
an initial real time, predetermined video advertisement segment including a dynamic sequence presenting a spokesperson representation having a plurality of selectable zones with each zone defined in relation to a unique part of the spokesperson representation; and
a plurality of selectable, predetermined video advertisement segments, presented as a continuation of the dynamic sequence of the spokesperson representation, each selectable video advertisement segment corresponding to one of the plurality of selectable zones and selectively delivered to a viewer in direct response to selection by the viewer of that zone.

2. The interactive video advertisement package of claim 1, wherein a transition occurs between the initial advertisement segment and the selected selectable advertisement segment and the transition is seamless.

3. The interactive video advertisement package of claim 2, wherein a transition is made seamless by en ding the initial advertisement segment and beginning each selectable advertisement segment using a common predetermined home position.

4. The interactive video advertisement package of claim 1, wherein at least two selectable zones are created from an image mapping of a video frame of an advertisement segment to demarcate a unique part of the spokesperson representation.

5. The interactive video advertisement package of claim 4, wherein at least one selectable zone includes a margin around a mapped image.

6. The interactive video advertisement package of claim 1, wherein at least one selectable advertisement segment includes a special effect of causing an object to appear as part of the spokesperson representation.

7. The interactive video advertisement package of claim 1, wherein viewer recognition of the spokesperson representation is inherent.

8. The interactive video advertisement package of claim 1, wherein viewer recognition of the spokesperson representation is created by repeated advertising exposure of the spokesperson representation.

9. The interactive video advertisement package of claim 1, wherein a real time picture-in-picture window selectable zone appears displaying real time video programming while the viewer is viewing one of the selectable advertisement segments in cyber time, and wherein the viewer is returned to real time video programming in direct response to selecting the real time selectable zone.

10. A method of presenting an interactive video advertisement package over a broadcast interactive television medium comprising:
simultaneously delivering an initial real time, predetermined video advertisement segment to a plurality of viewers over the broadcast interactive television medium, wherein the initial video advertisement segment includes a dynamic sequence presenting a spokesperson representation having a plurality of selectable zones with each zone defined in relation to a unique part of the spokesperson representation;
providing a plurality of selectable, predetermined video advertisement segments, presented as a continuation of the dynamic sequence of the spokesperson representation, each selectable video advertisement segment corresponding to one of the plurality of selectable zones; and
in response to selection of a selectable zone by one of the plurality of viewers, directly delivering the corresponding selectable video advertisement segment to that viewer.

11. A method of compensating a spokesperson used in an interactive video advertisement package delivered over a broadcast interactive television medium comprising:
preparing an initial real time, predetermined video advertisement segment, wherein the initial video advertisement segment includes a dynamic sequence presenting a representation of the spokesperson, the representation having a plurality of selectable zones with each zone defined in relation to a unique part of the representation;
preparing a plurality of selectable, predetermined video advertisement segments, each selectable video advertisement segment corresponding to one of the plurality of selectable zones and selectively deliverable over the broadcast interactive television medium;
delivering the initial video advertisement to a plurality of viewers over the broadcast interactive television medium;
in response to selection of a selectable zone by one of the plurality of viewers, directly delivering the corresponding selectable video advertisement segment to that viewer;
determining compensation to the spokesperson based at least in part on statistics associated with the delivery of the selectable video advertisement segments.

12. The method of claim 11 wherein the selectable zones represent different products of a plurality of parties and compensation to the spokesperson is paid by the plurality of parties based at least in part on the statistics associated with the delivery of the selectable video advertisement segments for each of the different products.

13. The method of claim 11 wherein a supplier of the broadcast interactive television medium is compensated based at least in part on a per time slot basis for delivery of the initial advertisement video segment and in part on a per selection basis for delivery of the selectable advertisement video segments.
